(19) United States
(12) Patent Application Publication
(10) Pub. No.: US 2011/0027714 A1
(43) Pub. Date: Feb. 3, 2011

(54) TONER COMPOSITIONS

(75) Inventors: Maria N.V. McDougall, Oakville (CA); Richard P.N. Veregin, Mississauga (CA); Wafa Bashir, Mississauga (CA); Michael S. Hawkins, Cambridge (CA); Eric Rotberg, Toronto (CA); Sonja Hadzidedic, Oakville (CA)

Correspondence Address: Xerox Corporation (CDFS), 445 Broad Hollow Rd.-Suite 420, Melville, NY, 11747, US

(73) Assignee: XEROX CORPORATION, Norwalk, CT (US)

(21) Appl. No.: 12/511,334

(22) Filed: Jul. 29, 2009

(51) Int. Cl. G03G 9/08; G03G 9/09

(52) U.S. Cl. 430/108.11; 430/108.3

(57) ABSTRACT

Toner particles are provided which may, in embodiments, include an additive package possessing both a silica that has been treated with polydimethyl siloxane and a titanium dioxide that has been subjected to a fluorine treatment. The silica that has been treated with polydimethyl siloxane has low levels of free polydimethyl siloxane. The combined additives provide toners with excellent charging characteristics and good blocking performance.

### BACKGROUND

The present disclosure relates to toners suitable for electrophotographic apparatuses.

Numerous processes are within the purview of those skilled in the art for the preparation of toners. Emulsion aggregation (EA) is one such method. These toners may be formed by aggregating a colorant with a latex polymer formed by emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. Other examples of emulsion/aggregation/coalescing processes for the preparation of toners are illustrated in U.S. Pat. Nos. 5,403,693, 5,418,108, 5,364,729, and 5,346,797, the disclosures of each of which are hereby incorporated by reference in their entirety. Other processes are disclosed in U.S. Pat. Nos. 5,527,658, 5,585,215, 5,650,255, 5,650,256 and 5,501,935, the disclosures of each of which are hereby incorporated by reference in their entirety. Other patents disclosing exemplary emulsion aggregation/coalescing processes include, for example, U.S. Pat. Nos. 6,730,450, 6,743,559, 6,756,176, 6,780,500, 6,830,860, 6,887,518, and 7,029,817 the disclosures of each of which are hereby incorporated by reference in their entirety.

Polyester EA ultra low melt (ULM) toners have been prepared utilizing amorphous and crystalline polyester resins. An issue which may arise with this formulation is that the additive packages included in developers possessing such toners might not possess good blocking performance and good fusing properties, which may be desirable for lower energy consumption and higher print speeds.

Improved processes for producing toners remain desirable.

### SUMMARY

The present disclosure provides toners and processes for making such toners. In embodiments, a toner of the present disclosure may include a resin; an optional colorant; an optional wax; and at least one additive including a silica treated with a polydimethyl siloxane, having from about 0 ppm by weight to about 10,000 ppm by weight free polydimethyl siloxane.

In other embodiments, a toner of the present disclosure may include at least one amorphous polyester resin, optionally in combination with at least one crystalline polyester resin; an optional colorant; an optional wax; and at least one additive including a silica treated with a polydimethyl siloxane, having from about 0 ppm by weight to about 10000 ppm by weight free polydimethyl siloxane, in combination with titanium dioxide treated with fluorine, the fluorine present in an amount of from about 1% by weight of the titanium dioxide to about 20% by weight of the titanium dioxide.

In yet other embodiments, a toner of the present disclosure may include at least one amorphous polyester resin, optionally in combination with at least one crystalline polyester resin; an optional colorant; an optional wax; and at least one additive including a silica treated with a polydimethyl siloxane, having from about 0 ppm by weight to about 10,000 ppm by weight free polydimethyl siloxane, in combination with titanium dioxide treated with fluorine, the fluorine present in an amount of from about 1% by weight of the titanium dioxide to about 20% by weight of the titanium dioxide, wherein the silica treated with the polydimethyl siloxane is present in an amount of from about 0.5% by weight of the toner to about 3% by weight of the toner, and wherein the titanium dioxide treated with fluorine is present in an amount of from about 0.1% by weight of the toner to about 2.5% by weight of the toner.

### BRIEF DESCRIPTION OF THE DRAWINGS

Various embodiments of the present disclosure will be described herein below with reference to the figures wherein:

FIG. 1 is a graph of blocking data for a toner of the present disclosure having a silica with low amounts of free PDMS compared with a toner having a silica with high amounts of free PDMS;

FIG. 2 is a graph showing the optimization of blocking data for a toner of the present disclosure having a silica with low amounts of free PDMS compared with a toner having a silica with high amounts of free PDMS;

FIG. 3 is a graph depicting RH sensitivity for developers prepared with a toner of the present disclosure having fluorinated treated titanium dioxide compared with toners not having the fluorinated treated titanium dioxide;

FIG. 4 is a graph depicting the formulation range of silica/titania ratio and total additive surface area coverage for both additive formulations, silica having low levels of free PDMS and the titanium dioxide that provides both acceptable blocking performance and acceptable transfer efficiency (TE); and

FIG. 5 is a graph showing blocking data for toners of the present disclosure possessing both silica with low amounts of free PDMS and fluorinated treated titanium dioxide, compared with toners possessing silica with high amounts of free PDMS and titanium dioxide that had not been treated with fluorine.

### DETAILED DESCRIPTION

The present disclosure provides developer compositions having excellent fusing properties. The developer compositions include a ULM EA toner in combination with an optimized additive package including a hydrophobic amorphous silica having low levels of free polydimethylsiloxane (PDMS) and, in embodiments, a titanium dioxide that has been subjected to a fluorine treatment.

### Resins

Any latex resin may be utilized in forming a toner of the present disclosure. Such resins, in turn, may be made of any suitable monomer. Any monomer employed may be selected depending upon the particular polymer to be utilized.

In embodiments, the resins may be an amorphous resin, a crystalline resin, and/or a combination thereof. In further embodiments, the polymer utilized to form the resin may be a polyester resin, including the resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 1,6-hexanediol, 1,7-heptanediol, 1,8-octanediol, 1,9-nonanediol, 1,10-decanediol, 1,12-dodecanediol and the like; alkali sulfo-aliphatic diols such as sodio 2-sulfo-1,2-ethanediol, lithio 2-sulfo-1,2-ethanediol, potassio 2-sulfo-1,2-ethanediol, sodio 2-sulfo-1,3-propanediol, lithio 2-sulfo-1,3-propanediol, potassio 2-sulfo-1,3-propanediol, mixture thereof, and the like. The aliphatic diol may be, for example, selected in an amount of from about 40 to about 60 mole percent, in embodiments from about 42 to about 55 mole percent, in embodiments from about 45 to about 53 mole percent, and the alkali sulfo-aliphatic diol can be selected in an amount of from about 0 to about 10 mole percent, in embodiments from about 1 to about 4 mole percent of the resin.

Examples of organic diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis,1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof; and an alkali sulfo-organic diacid such as the sodio, lithio or potassio salt of dimethyl-5-sulfo-isophthalate, dialkyl-5-sulfo-isophthalate-4-sulfo-1,8-naphthalic anhydride, 4-sulfo-phthalic acid, dimethyl-4-sulfo-phthalate, dialkyl-4-sulfo-phthalate, 4-sulfophenyl-3,5-dicarbomethoxybenzene, 6-sulfo-2-naphthyl-3,5-dicarbomethoxybenzene, sulfo-terephthalic acid, dimethyl-sulfo-terephthalate, 5-sulfo-isophthalic acid, dialkyl-sulfo-terephthalate, sulfoethanediol, 2-sulfopropanediol, 2-sulfobutanediol, 3-sulfopentanediol, 2-sulfohexanediol, 3-sulfo-2-methylpentanediol, 2-sulfo-3,3-dimethylpentanediol, sulfo-p-hydroxybenzoic acid, N,N-bis(2-hydroxyethyl)-2-amino ethane sulfonate, or mixtures thereof. The organic diacid may be selected in an amount of, for example, in embodiments from about 40 to about 60 mole percent, in embodiments from about 42 to about 52 mole percent, in embodiments from about 45 to about 50 mole percent, and the alkali sulfo-aliphatic diacid can be selected in an amount of from about 1 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), polypropylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), alkali copoly(5-sulfoisophthaloyl)-copoly(ethylene-adipate), alkali copoly(5-sulfoisophthaloyl)-copoly(propylene-adipate), alkali copoly(5-sulfoisophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfo-isophthaloyl)-copoly(ethylene-adipate), alkali copoly(5-sulfo-isophthaloyl)-copoly (propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), alkali copoly(5-sulfo-isophthaloyl)-copoly(octylene-adipate), alkali copoly(5-sulfoisophthaloyl)-copoly(ethylene-succinate), alkali copoly(5-sulfoisophthaloyl)-copoly(propylene-succinate), alkali copoly(5-sulfoisophthaloyl)-copoly(butylenes-succinate), alkali copoly(5-sulfoisophthaloyl)-copoly(pentylene-succinate), alkali copoly(5-sulfoisophthaloyl)-copoly(hexylene-succinate), alkali copoly(5-sulfoisophthaloyl)-copoly(octylene-succinate), alkali copoly(5-sulfo-isophthaloyl)-copoly(ethylene-sebacate), alkali copoly(5-sulfo-isophthaloyl)-copoly(propylene-sebacate), alkali copoly(5-sulfo-isophthaloyl)-copoly(butylene-sebacate), alkali copoly(5-sulfo-isophthaloyl)-copoly(pentylene-sebacate), alkali copoly(5-sulfo-isophthaloyl)-copoly(hexylene-sebacate), alkali copoly(5-sulfo-isophthaloyl)-copoly(octylene-sebacate), alkali copoly(5-sulfo-isophthaloyl)-copoly(ethylene-adipate), alkali copoly(5-sulfo-isophthaloyl)-copoly(propylene-adipate), alkali copoly(5-sulfo-isophthaloyl)-copoly(butylene-adipate), alkali copoly(5-sulfo-isophthaloyl)-copoly(pentylene-adipate), alkali copoly(5-sulfo-isophthaloyl)-copoly(hexylene-adipate), poly(octylene-adipate), wherein alkali is a metal like sodium, lithium or potassium. Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount of from about 5 to about 50 percent by weight of the toner components, in embodiments from about 10 to about 35 percent by weight of the toner components. The crystalline resin can possess various melting points of, for example, from about 30° C. to about 120° C., in embodiments from about 50° C. to about 90° C. The crystalline resin may have a number average molecular weight (Mₙ), as measured by gel permeation chromatography (GPC) of, for example, from about 1,000 to about 50,000, in embodiments from about 2,000 to about 25,000, and a weight average molecular weight (M_{w}) of, for example, from about 2,000 to about 100,000, in embodiments from about 3,000 to about 80,000, as determined by Gel Permeation Chromatography using polystyrene standards. The molecular weight distribution (M_{w}/Mₙ) of the crystalline resin may be, for example, from about 2 to about 6, in embodiments from about 3 to about 4.

Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecane diacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacid or diester may be present, for example, in an amount from about 40 to about 60 mole percent of the resin, in embodiments from about 42 to about 52 mole percent of the resin, in embodiments from about 45 to about 50 mole percent of the resin.

Examples of diols which may be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl) oxide, dipropylene glycol, dibutylene, and combinations thereof. The amount of organic diol selected can vary, and may be present, for example, in an amount from about 40 to about 60 mole percent of the resin, in embodiments from about 42 to about 55 mole percent of the resin, in embodiments from about 45 to about 53 mole percent of the resin.

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, suitable amorphous resins include polyesters, polyamides, polyimides, polyolefins, polyethylene, polybutylene, polyisobutyrate, ethylene-propylene copolymers, ethylene-vinyl acetate copolymers, polypropylene, combinations thereof, and the like. Examples of amorphous resins which may be utilized include alkali sulfonated-polyester resins, branched alkali sulfonated-polyester resins, alkali sulfonated-polyimide resins, and branched alkali sulfonated-polyimide resins. Alkali sulfonated polyester resins may be useful in embodiments, such as the metal or alkali salts of copoly(ethylene-terephthalate)-copoly(ethylene-5-sulfo-isophthalate), copoly(propylene-terephthalate)-copoly(propylene-5-sulfo-isophthalate), copoly(diethylene-terephthalate)-copoly(diethylene-5-sulfo-isophthalate), copoly(propylene-diethylene-terephthalate)-copoly(propylene-diethylene-5-sulfoisophthalate), copoly(propylene-butylene-terephthalate)-copoly(propylene-butylene-5-sulfo-isophthalate), copoly(propoxylated bisphenol-A-fumarate)-copoly(propoxylated bisphenol A-5-sulfo-isophthalate), copoly(ethoxylated bisphenol-A-fumarate)-copoly(ethoxylated bisphenol-A-5-sulfo-isophthalate), and copoly(ethoxylated bisphenol-A-maleate)-copoly(ethoxylated bisphenol-A-5-sulfo-isophthalate), wherein the alkali metal is, for example, a sodium, lithium or potassium ion.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

In embodiments, a suitable polyester resin may be an amorphous polyester such as a poly(propoxylated bisphenol A co-fumarate) resin having the following formula (I):

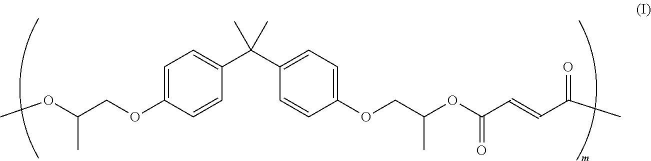

wherein m may be from about 5 to about 1000. Examples of such resins and processes for their production include those disclosed in U.S. Pat. No. 6,063,827, the disclosure of which is hereby incorporated by reference in its entirety.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, North Carolina, and the like.

Suitable crystalline resins which may be utilized, optionally in combination with an amorphous resin as described above, include those disclosed in U.S. Patent Application Publication No. 2006/0222991, the disclosure of which is hereby incorporated by reference in its entirety. In embodiments, a suitable crystalline resin may include a resin formed of ethylene glycol and a mixture of dodecanedioic acid and fumaric acid co-monomers with the following formula:

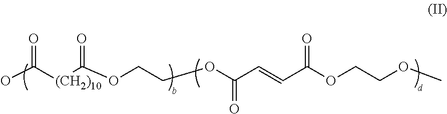

wherein b is from about 5 to about 2000 and d is from about 5 to about 2000.

For example, in embodiments, a poly(propoxylated bisphenol A co-fumarate) resin of formula I as described above may be combined with a crystalline resin of formula II.

In embodiments, the resin may be a crosslinkable resin. A crosslinkable resin is a resin including a crosslinkable group or groups such as a C═C bond. The resin can be crosslinked, for example, through a free radical polymerization with an initiator. Thus, in embodiments, a resin may be partially crosslinked, which may be referred to, in embodiments, as a “partially crosslinked polyester resin” or a “polyester gel”. In embodiments, from about 1% by weight to about 50% by weight of the polyester gel may be crosslinked, in embodiments from about 5% by weight to about 35% by weight of the polyester gel may be crosslinked.

In embodiments, the amorphous resins described above may be partially crosslinked. For example, an amorphous resin which may be crosslinked and used in forming a toner particle in accordance with the present disclosure may include a crosslinked amorphous polyester of formula I above. Methods for forming the polyester gel include those within the purview of those skilled in the art. For example, crosslinking may be achieved by combining an amorphous resin with a crosslinker, sometimes referred to herein, in embodiments, as an initiator. Examples of suitable crosslinkers include, but are not limited to, for example, free radical or thermal initiators such as organic peroxides and azo compounds. Examples of suitable organic peroxides include diacyl peroxides such as, for example, decanoyl peroxide, lauroyl peroxide and benzoyl peroxide, ketone peroxides such as, for example, cyclohexanone peroxide and methyl ethyl ketone, alkyl peroxyesters such as, for example, t-butyl peroxy neodecanoate, 2,5-dimethyl 2,5-di (2-ethyl hexanoyl peroxy) hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, oo-t-butyl o-isopropyl mono peroxy carbonate, 2,5-dimethyl 2,5-di (benzoyl peroxy) hexane, oo-t-butyl o-(2-ethyl hexyl) mono peroxy carbonate, and oo-t-amyl o-(2-ethyl hexyl) mono peroxy carbonate, alkyl peroxides such as, for example, dicumyl peroxide, 2,5-dimethyl 2,5-di (t-butyl peroxy) hexane, t-butyl cumyl peroxide, α-α-bis(t-butyl peroxy) diisopropyl benzene, di-t-butyl peroxide and 2,5-dimethyl 2,5di (t-butyl peroxy) hexyne-3, alkyl hydroperoxides such as, for example, 2,5-dihydro peroxy 2,5-dimethyl hexane, cumene hydroperoxide, t-butyl hydroperoxide and t-amyl hydroperoxide, and alkyl peroxyketals such as, for example, n-butyl 4,4-di (t-butyl peroxy) valerate, 1,1-di (t-butyl peroxy) 3,3,5-trimethyl cyclohexane, 1,1-di (t-butyl peroxy) cyclohexane, 1,1-di (t-amyl peroxy) cyclohexane, 2,2di (t-butyl peroxy) butane, ethyl 3,3-di (t-butyl peroxy) butyrate and ethyl 3,3-di (t-amyl peroxy) butyrate, and combinations thereof. Examples of suitable azo compounds include 2,2,′-azobis(2,4-dimethylpentane nitrile), azobis-isobutyronitrile, 2,2′-azobis (isobutyronitrile), 2,2′-azobis (2,4-dimethyl valeronitrile), 2,2′-azobis (methyl butyronitrile), 1,1′-azobis (cyano cyclohexane), other similar known compounds, and combinations thereof.

Although any suitable initiator can be used, in embodiments the initiator may be an organic initiator that is soluble in any solvent present, but not soluble in water. For example, half-life/temperature characteristic plots for VAZO® 52 (2,2,′-azobis(2,4-dimethylpentane nitrile), commercially available from E. I. du Pont de Nemours and Company, USA) shows a half-life greater than about 90 minutes at about 65° C. and less than about 20 minutes at about 80° C.

Where utilized, the initiator may be present in an amount of from about 0.5% by weight to about 20% by weight of the resin, in embodiments from about 1% by weight to about 10% by weight of the resin.

The crosslinker and amorphous resin may be combined for a sufficient time and at a sufficient temperature to form the crosslinked polyester gel. In embodiments, the crosslinker and amorphous resin may be heated to a temperature of from about 25° C. to about 99° C., in embodiments from about 40° C. to about 95° C., for a period of time of from about 1 minute to about 10 hours, in embodiments from about 5 minutes to about 5 hours, to form a crosslinked polyester resin or polyester gel suitable for use in forming toner particles.

In embodiments, the resins utilized in forming toner particles may have a glass transition temperature of from about 30° C. to about 80° C., in embodiments from about 35° C. to about 70° C. In further embodiments, the resins utilized in forming toner particles may have a melt viscosity of from about 10 to about 1,000,000 Pa*S at about 130° C., in embodiments from about 20 to about 100,000 Pa*S.

One, two, or more toner resins may be used. In embodiments where two or more toner resins are used, the toner resins may be in any suitable ratio (e.g., weight ratio) such as for instance about 10% (first resin)/90% (second resin) to about 90% (first resin)/10% (second resin).

In embodiments, the resin may be formed by emulsion polymerization methods.

### Toner

The resin described above may be utilized to form toner compositions. Such toner compositions may include optional colorants, waxes, and other additives. Toners may be formed utilizing any method within the purview of those skilled in the art.

### Surfactants

In embodiments, the colorants, waxes, and other additives utilized to form toner compositions may be in dispersions including surfactants. Moreover, toner particles may be formed by emulsion aggregation methods where the resin and other components of the toner are placed in one or more surfactants, an emulsion is formed, toner particles are aggregated, coalesced, optionally washed and dried, and recovered.

One, two, or more surfactants may be utilized. The surfactants may be selected from ionic surfactants and nonionic surfactants. Anionic surfactants and cationic surfactants are encompassed by the term “ionic surfactants.” In embodiments, the surfactant may be utilized so that it is present in an amount of from about 0.01% to about 5% by weight of the toner composition, for example from about 0.75% to about 4% by weight of the toner composition, in embodiments from about 1% to about 3% by weight of the toner composition.

Examples of nonionic surfactants that can be utilized include, for example, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants include a block copolymer of polyethylene oxide and polypropylene oxide, including those commercially available as SYNPERONIC PE/F, in embodiments SYNPERONIC PE/F 108.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include, in embodiments, DOWFAX™ 2A1, an alkyldiphenyloxide disulfonate from The Dow Chemical Company, and/or TAYCA POWER BN2060 from Tayca Corporation (Japan), which are branched sodium dodecyl benzene sulfonates. Combinations of these surfactants and any of the foregoing anionic surfactants may be utilized in embodiments.

Examples of the cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, and mixtures thereof.

### Colorants

As the colorant to be added, various known suitable colorants, such as dyes, pigments, mixtures of dyes, mixtures of pigments, mixtures of dyes and pigments, and the like, may be included in the toner. The colorant may be included in the toner in an amount of, for example, about 0.1 to about 35 percent by weight of the toner, or from about 1 to about 15 weight percent of the toner, or from about 3 to about 10 percent by weight of the toner.

As examples of suitable colorants, mention may be made of carbon black like REGAL 330®; magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, S610™; Northern Pigments magnetites, NP604™, NP608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI-60710, CI Dispersed Red 15, diazo dye identified in the Color Index as CI-26050, CI Solvent Red 19, and the like. Illustrative examples of cyans include copper tetra(octadecyl sulfonamido) phthalocyanine, x-copper phthalocyanine pigment listed in the Color Index as CI 74160, CI Pigment Blue, Pigment Blue 15:3, and Anthrathrene Blue, identified in the Color Index as CI 69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Optionally, a wax may also be combined with the resin and optional colorant in forming toner particles. When included, the wax may be present in an amount of, for example, from about 1 weight percent to about 25 weight percent of the toner particles, in embodiments from about 5 weight percent to about 20 weight percent of the toner particles.

Waxes that may be selected include waxes having, for example, a weight average molecular weight of from about 500 to about 20,000, in embodiments from about 1,000 to about 10,000. Waxes that may be used include, for example, polyolefins such as polyethylene, polypropylene, and polybutene waxes such as commercially available from Allied Chemical and Petrolite Corporation, for example POLYWAX™ polyethylene waxes from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax, and Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethyleneglycol monostearate, dipropyleneglycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents.

### Toner Preparation

The toner particles may be prepared by any method within the purview of one skilled in the art. Although embodiments relating to toner particle production are described below with respect to emulsion-aggregation processes, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion-aggregation processes, such as a process that includes aggregating a mixture of an optional colorant, an optional wax and any other desired or required additives, and emulsions including the resins described above, optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. In embodiments, the pH of the mixture may be adjusted to from about 4 to about 5. Additionally, in embodiments, the mixture may be homogenized. If the mixture is homogenized, homogenization may be accomplished by mixing at about 600 to about 4,000 revolutions per minute. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

The aggregating agent may be added to the mixture utilized to form a toner in an amount of, for example, from about 0.1% to about 8% by weight, in embodiments from about 0.2% to about 5% by weight, in other embodiments from about 0.5% to about 5% by weight, of the resin in the mixture. This provides a sufficient amount of agent for aggregation.

In order to control aggregation and subsequent coalescence of the particles, in embodiments the aggregating agent may be metered into the mixture over time. For example, the agent may be metered into the mixture over a period of from about 5 to about 240 minutes, in embodiments from about 30 to about 200 minutes. The addition of the agent may also be done while the mixture is maintained under stirred conditions, in embodiments from about 50 rpm to about 1,000 rpm, in other embodiments from about 100 rpm to about 500 rpm, and at a temperature that is below the glass transition temperature of the resin as discussed above, in embodiments from about 30° C. to about 90° C., in embodiments from about 35° C. to about 70° C.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 30° C. to about 99° C., and holding the mixture at this temperature for a time from about 0.5 hours to about 10 hours, in embodiments from about hour 1 to about 5 hours, while maintaining stirring, to provide the aggregated particles. Once the predetermined desired particle size is reached, then the growth process is halted. In embodiments, the predetermined desired particle size is within the toner particle size ranges mentioned above.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C., which may be below the glass transition temperature of the resin as discussed above.

Once the desired final size of the toner particles is achieved, the pH of the mixture may be adjusted with a base to a value of from about 3 to about 10, and in embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

### Shell Resin

In embodiments, after aggregation, but prior to coalescence, a shell may be applied to the aggregated particles.

Resins which may be utilized to form the shell include, but are not limited to, the amorphous resins described above. In embodiments, an amorphous resin which may be used to form a shell in accordance with the present disclosure may include an amorphous polyester of formula I above.

In some embodiments, the amorphous resin utilized to form the shell may be crosslinked. For example, crosslinking may be achieved by combining an amorphous resin with a crosslinker, sometimes referred to herein, in embodiments, as an initiator. Examples of suitable crosslinkers include, but are not limited to, for example free radical or thermal initiators such as organic peroxides and azo compounds described above as suitable for forming a gel in the core. Examples of suitable organic peroxides include diacyl peroxides such as, for example, decanoyl peroxide, lauroyl peroxide and benzoyl peroxide, ketone peroxides such as, for example, cyclohexanone peroxide and methyl ethyl ketone, alkyl peroxyesters such as, for example, t-butyl peroxy neodecanoate, 2,5-dimethyl 2,5-di (2-ethyl hexanoyl peroxy) hexane, t-amyl peroxy 2-ethyl hexanoate, t-butyl peroxy 2-ethyl hexanoate, t-butyl peroxy acetate, t-amyl peroxy acetate, t-butyl peroxy benzoate, t-amyl peroxy benzoate, oo-t-butyl o-isopropyl mono peroxy carbonate, 2,5-dimethyl 2,5-di (benzoyl peroxy) hexane, oo-t-butyl o-(2-ethyl hexyl) mono peroxy carbonate, and oo-t-amyl o-(2-ethyl hexyl) mono peroxy carbonate, alkyl peroxides such as, for example, dicumyl peroxide, 2,5-dimethyl 2,5-di (t-butyl peroxy) hexane, t-butyl cumyl peroxide, α-α-bis(t-butyl peroxy) diisopropyl benzene, di-t-butyl peroxide and 2,5-dimethyl 2,5di (t-butyl peroxy) hexyne-3, alkyl hydroperoxides such as, for example, 2,5-dihydro peroxy 2,5-dimethyl hexane, cumene hydroperoxide, t-butyl hydroperoxide and t-amyl hydroperoxide, and alkyl peroxyketals such as, for example, n-butyl 4,4-di (t-butyl peroxy) valerate, 1,1-di (t-butyl peroxy) 3,3,5-trimethyl cyclohexane, 1,1-di (t-butyl peroxy) cyclohexane, 1,1-di (t-amyl peroxy) cyclohexane, 2,2-di (t-butyl peroxy) butane, ethyl 3,3-di (t-butyl peroxy) butyrate and ethyl 3,3-di (t-amyl peroxy) butyrate, and combinations thereof. Examples of suitable azo compounds include 2,2,′-azobis(2,4-dimethylpentane nitrile), azobis-isobutyronitrile, 2,2′-azobis (isobutyronitrile), 2,2′-azobis (2,4-dimethyl valeronitrile), 2,2′-azobis (methyl butyronitrile), 1,1′-azobis (cyano cyclohexane), other similar known compounds, and combinations thereof.

The crosslinker and amorphous resin may be combined for a sufficient time and at a sufficient temperature to form the crosslinked polyester gel. In embodiments, the crosslinker and amorphous resin may be heated to a temperature of from about 25° C. to about 99° C., in embodiments from about 30° C. to about 95° C., for a period of time of from about 1 minute to about 10 hours, in embodiments from about 5 minutes to about 5 hours, to form a crosslinked polyester resin or polyester gel suitable for use as a shell.

Where utilized, the crosslinker may be present in an amount of from about 0.001% by weight to about 5% by weight of the resin, in embodiments from about 0.01% by weight to about 1% by weight of the resin.

A single polyester resin may be utilized as the shell or, in embodiments, a first polyester resin may be combined with other resins to form a shell. Multiple resins may be utilized in any suitable amounts. In embodiments, a first amorphous polyester resin, for example an amorphous resin of formula I above, may be present in an amount of from about 20 percent by weight to about 100 percent by weight of the total shell resin, in embodiments from about 30 percent by weight to about 90 percent by weight of the total shell resin. Thus, in embodiments, a second resin may be present in the shell resin in an amount of from about 0 percent by weight to about 80 percent by weight of the total shell resin, in embodiments from about 10 percent by weight to about 70 percent by weight of the shell resin.

### Coalescence

Following aggregation to the desired particle size and the optional application of a shell resin described above, the particles may then be coalesced to the desired final shape, the coalescence being achieved by, for example, heating the mixture to a suitable temperature. This temperature may, in embodiments, be from about 0° C. to about 50° C. higher than the onset melting point of the crystalline polyester resin utilized in the core, in other embodiments from about 5° C. to about 30° C. higher than the onset melting point of the crystalline polyester resin utilized in the core. For example, by utilizing the polyester gel in forming a shell as described above, in embodiments the temperature for coalescence may be from about 40° C. to about 99° C., in embodiments from about 50° C. to about 95° C. Higher or lower temperatures may be used, it being understood that the temperature is a function of the resins used.

Coalescence may also be carried out with stirring, for example at a speed of from about 50 rpm to about 1,000 rpm, in embodiments from about 100 rpm to about 600 rpm. Coalescence may be accomplished over a period of from about 1 minute to about 24 hours, in embodiments from about 5 minutes to about 10 hours.

After coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

In embodiments, toners of the present disclosure may be utilized as ultra low melt (ULM) toners. In embodiments, the dry toner particles of the present disclosure may, exclusive of external surface additives, have the following characteristics:

(1) Volume average diameter (also referred to as “volume average particle diameter”) of from about 3 to about 25 μm, in embodiments from about 4 to about 15 μm, in other embodiments from about 5 to about 12 μm.

(2) Number Average Geometric Size Distribution (GSDn) and/or Volume Average Geometric Size Distribution (GSDv) of from about 1.05 to about 1.55, in embodiments from about 1.1 to about 1.4.

(3) Circularity of from about 0.93 to about 1, in embodiments from about 0.95 to about 0.99 (measured with, for example, a Sysmex FPIA 2100 analyzer).

The characteristics of the toner particles may be determined by any suitable technique and apparatus. Volume average particle diameter D₅₀ᵥ, GSDv, and GSDn may be measured by means of a measuring instrument such as a Beckman Coulter Multisizer 3, operated in accordance with the manufacturer's instructions. Representative sampling may occur as follows: a small amount of toner sample, about 1 gram, may be obtained and filtered through a 25 micrometer screen, then put in isotonic solution to obtain a concentration of about 10%, with the sample then run in a Beckman Coulter Multisizer 3.

### Additives

In embodiments, the toner particles may also contain other optional additives, as desired or required. For example, there can be blended with the toner particles external additive particles including flow aid additives, which additives may be present on the surface of the toner particles. Examples of these additives include metal oxides such as titanium oxide, silicon oxide, tin oxide, mixtures thereof, and the like; colloidal and amorphous silicas, such as AEROSIL®, metal salts and metal salts of fatty acids inclusive of zinc stearate, aluminum oxides, cerium oxides, and mixtures thereof. In embodiments, these metal oxides and other additives may improve toner relative humidity (RH) sensitivity, as well as flow and blocking properties. These metal oxides may include nano size amorphous particles that also have important functions during printing such as enabling development, and transfer of toner to the substrate.

Many developers use polydimethyl siloxane (PDMS) treated silica as a major component of the additive package because it offers very good charging; however, with ultra low melt toners, which may include polyesters containing a small amount of crystalline resin, a lower temperature blocking may occur. Without wishing to be bound by any theory, free PDMS in the treated silica may plasticize the toner, making its surface soft and tacky, and easy to agglomerate when exposed at temperatures above the glass transition temperature (Tg) of the resin.

In accordance with the present disclosure, a modified additive design is provided having a total surface area coverage (SAC) of two additives, including a silica with low amounts of free PDMS, and a titanium dioxide in amounts from about 35 to 80 percent by weight, in embodiments from about 40 to 70 percent by weight. The SAC is calculated as % SAC=100*additive wt %/((0.363*additive size(nm)*additive density(g/cm³))/(toner size(m)*toner density(g/cm³)).

In accordance with the present disclosure, a modified additive design is provided having a silica/titania weight ratio of from about 0.5 to about 2.7, in embodiments from about 0.85 to about 2.5. (In accordance with the present disclosure, a silica having low levels of free PDMS may be used, in embodiments a silica having from about 0 ppm about 10,000 ppm free PDMS by weight, in embodiments from about 5 ppm to about 5000 ppm free PDMS by weight, in embodiments from about 10 ppm to about 3000 ppm free PDMS by weight, in other embodiments from about 15 ppm to about 1000 ppm free PDMS by weight. In embodiments, a silica with low amounts of free PDMS by weight that may be used may include H05TD, commercially available from Wacker.

Such a PDMS treated silica may be present in an amount of from about 0.5% by weight to about 3% by weight of the toner, in embodiments from about 0.8% by weight to about 2.7% by weight of the toner.

The above silica, with low levels of free PDMS, may be combined, in embodiments, with a titanium dioxide that has been treated with fluorine. Such fluorine surface treatments include, for example, a polymer containing fluorine atoms, a surfactant containing fluorine atoms, a silane containing fluorine atoms, combinations thereof, and the like. Examples of titanium dioxide that has been treated with fluorine that may be utilized is STT100H-F10 and STT100H-F20, which are commercially available from Titan Kogyo. Fluorinated titanium dioxide may possess fluorine in amounts of from about 1% by weight of the titanium dioxide to about 20% by weight of the titanium dioxide, in embodiments from about 2% by weight of the titanium dioxide to about 10% by weight of the titanium dioxide.

Fluorinated titanium dioxide may be added in amounts of from about 0.1% by weight to about 2.5% by weight of the toner, in embodiments from about 0.3% by weight to about 2.2% by weight of the toner.

In embodiments, the use of a fluorinated titania may result in improved charge characteristics, which may permit optimization of toner properties. For example, the use of a fluorinated titania may reduce the amount of silica needed, permitting one to obtain even better relative humidity (RH) performance, as silica has a higher RH sensitivity than the fluorinated titania.

In embodiments, a combination of the silica having low levels of free PDMS and a titanium dioxide with a fluoro containing surface treatment may be utilized. Where the additive package of the present disclosure includes such a combination, the silica having low levels of free PDMS may be present in an amount of from about 0.5% by weight to about 3% by weight of the additive package, in embodiments from about 0.8% by weight to about 2.7% by weight of the additive package, and the titanium dioxide with a fluoro containing surface treatment may be present in an amount of from about 0.1% by weight to about 2.5% by weight of the additive package, in embodiments from about 0.3% by weight to about 2.2% by weight of the additive package.

Toners possessing the above additive package, with both the silica having low levels of free PDMS and the titanium dioxide with the fluoro containing surface treatment, may thus possess silicon dioxide and titanium dioxide in the toner at a ratio of from about 0.5:1 to about 2.7:1, in embodiments from about 0.85:1 to about 2.5:1.

It has been surprisingly found that these additives both increase the blocking temperature of EA ULM toners, from about 53° C. for an EA ULM possessing a conventional additive package, to from about 53.5° C. to about 60° C., in embodiments from about 54 to about 55° C., in embodiments about 54.4° C. These improvements are very important because they have potential for cost reduction, with lower amounts of additives required based on the more effective silica and fluoro treated titanium dioxide.

The additive package may be present in an amount of from about 0.1 percent by weight to about 5 percent by weight of the toner, in embodiments of from about 0.25 percent by weight to about 3 percent by weight of the toner.

Toners produced in accordance with the present disclosure may possess excellent charging characteristics when exposed to extreme relative humidity (RH) conditions. The low-humidity zone (C zone) may be about 10° C./15% RH, while the high humidity zone (A zone) may be about 28° C./85% RH. Final toners of the present disclosure may possess A zone charging of from about 15 μC/g to about 70 μC/g, in embodiments from about 20 μC/g to about 60 μC/g, and C-zone charging from about 15 μC/g to about 80 μC/g, in embodiments from about 25 μC/g to about 70 μC/g,

In accordance with the present disclosure, the charging of the toner particles may be enhanced, so less surface additives may be required, and the final toner charging may thus be higher to meet machine charging requirements.

For example, the additive packages of the present disclosure may, in embodiments, improve blocking and charging characteristics of the toner particles, including A-zone charging.

### Developers

The toner particles thus obtained may be formulated into a developer composition. The toner particles may be mixed with carrier particles to achieve a two-component developer composition. The toner concentration in the developer may be from about 1% to about 25% by weight of the total weight of the developer, in embodiments from about 2% to about 15% by weight of the total weight of the developer.

### Carriers

Examples of carrier particles that can be utilized for mixing with the toner include those particles that are capable of triboelectrically obtaining a charge of opposite polarity to that of the toner particles. Illustrative examples of suitable carrier particles include granular zircon, granular silicon, glass, steel, nickel, ferrites, iron ferrites, silicon dioxide, and the like. Other carriers include those disclosed in U.S. Pat. Nos. 3,847,604, 4,937,166, and 4,935,326.

The selected carrier particles can be used with or without a coating. In embodiments, the carrier particles may include a core with a coating thereover which may be formed from a mixture of polymers that are not in close proximity thereto in the triboelectric series. The coating may include fluoropolymers, such as polyvinylidene fluoride resins, terpolymers of styrene, methyl methacrylate, and/or silanes, such as triethoxy silane, tetrafluoroethylenes, other known coatings and the like. For example, coatings containing polyvinylidenefluoride, available, for example, as KYNAR 301F™, and/or polymethylmethacrylate, for example having a weight average molecular weight of about 300,000 to about 350,000, such as commercially available from Soken, may be used. In embodiments, polyvinylidenefluoride and polymethylmethacrylate (PMMA) may be mixed in proportions of from about 30 to about 70 weight % to about 70 to about 30 weight %, in embodiments from about 40 to about 60 weight % to about 60 to about 40 weight %. The coating may have a coating weight of, for example, from about 0.1 to about 5% by weight of the carrier, in embodiments from about 0.5 to about 2% by weight of the carrier.

In embodiments, PMMA may optionally be copolymerized with any desired comonomer, so long as the resulting copolymer retains a suitable particle size. Suitable comonomers can include monoalkyl, or dialkyl amines, such as a dimethylaminoethyl methacrylate, diethylaminoethyl methacrylate, diisopropylaminoethyl methacrylate, or t-butylaminoethyl methacrylate, and the like. The carrier particles may be prepared by mixing the carrier core with polymer in an amount from about 0.05 to about 10 percent by weight, in embodiments from about 0.01 percent to about 3 percent by weight, based on the weight of the coated carrier particles, until adherence thereof to the carrier core by mechanical impaction and/or electrostatic attraction.

Various effective suitable means can be used to apply the polymer to the surface of the carrier core particles, for example, cascade roll mixing, tumbling, milling, shaking, electrostatic powder cloud spraying, fluidized bed, electrostatic disc processing, electrostatic curtain, combinations thereof, and the like. The mixture of carrier core particles and polymer may then be heated to enable the polymer to melt and fuse to the carrier core particles. The coated carrier particles may then be cooled and thereafter classified to a desired particle size.

In embodiments, suitable carriers may include a steel core, for example of from about 25 to about 100 μm in size, in embodiments from about 50 to about 75 μm in size, coated with about 0.5% to about 10% by weight, in embodiments from about 0.7% to about 5% by weight, of a conductive polymer mixture including, for example, methylacrylate and carbon black using the process described in U.S. Pat. Nos. 5,236,629 and 5,330,874.

The carrier particles can be mixed with the toner particles in various suitable combinations. The concentrations are may be from about 1% to about 20% by weight of the toner composition. However, different toner and carrier percentages may be used to achieve a developer composition with desired characteristics.

### Imaging

The toners can be utilized for electrostatographic or xerographic processes, including those disclosed in U.S. Pat. No. 4,295,990, the disclosure of which is hereby incorporated by reference in its entirety. In embodiments, any known type of image development system may be used in an image developing device, including, for example, magnetic brush development, jumping single-component development, hybrid scavengeless development (HSD), and the like. These and similar development systems are within the purview of those skilled in the art.

Imaging processes include, for example, preparing an image with a xerographic device including a charging component, an imaging component, a photoconductive component, a developing component, a transfer component, and a fusing component. In embodiments, the development component may include a developer prepared by mixing a carrier with a toner composition described herein. The xerographic device may include a high speed printer, a black and white high speed printer, a color printer, and the like.

Once the image is formed with toners/developers via a suitable image development method such as any one of the aforementioned methods, the image may then be transferred to an image receiving medium such as paper and the like. In embodiments, the toners may be used in developing an image in an image-developing device utilizing a fuser roll member. Fuser roll members are contact fusing devices that are within the purview of those skilled in the art, in which heat and pressure from the roll may be used to fuse the toner to the image-receiving medium. In embodiments, the fuser member may be heated to a temperature above the fusing temperature of the toner, for example to temperatures of from about 70° C. to about 160° C., in embodiments from about 80° C. to about 150° C., in other embodiments from about 90° C. to about 140° C., after or during melting onto the image receiving substrate.

In embodiments where the toner resin is crosslinkable, such crosslinking may be accomplished in any suitable manner. For example, the toner resin may be crosslinked during fusing of the toner to the substrate where the toner resin is crosslinkable at the fusing temperature. Crosslinking also may be affected by heating the fused image to a temperature at which the toner resin will be crosslinked, for example in a post-fusing operation. In embodiments, crosslinking may be effected at temperatures of from about 160° C. or less, in embodiments from about 70° C. to about 160° C., in other embodiments from about 80° C. to about 140° C.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

Three batches of EA ultra-low melt toner particles were prepared with the same formulation and then blended with different additive packages for evaluation. In a typical toner particle preparation, a cyan polyester toner was prepared at the 20 gallon scale (about 8.5 kg dry theoretical toner), homogenizing about 78.7 percent on a dry weight basis of poly(propoxylated bisphenol A-co-fumaric acid) amorphous resin emulsion at 35% solids loading, about 6.8 wt % on a dry weight basis of poly(dodecandioicacid-co-nonanediol) crystalline resin emulsion at 30% solids loading, aluminum sulfate, about 9 wt % on a dry weight basis of a polyetheylene wax at 30% solids loading about 5.5 wt % on a dry weight basis of a Pigment Blue 15:3 pigment dispersion, at 17% solids loading, and additional distilled water to make a final solids content of between 11% and 14%, for about 60 minutes, then aggregating to a batch temperature of about 45° C. During aggregation, a shell including the same amorphous emulsions in the core was added to achieve the targeted particle size; with pH adjustment using sodium hydroxide and Versene-100 the aggregation step was frozen. The process continued with the reactor temperature increased to about 85° C. while maintaining a pH≧7.5 until the temperature was about 85° C., where the particles are coalesced as follows. The pH of the toner slurry was about 7.5 at which time about 1.3 kg of about 0.3M nitric acid was added until the toner slurry was at a pH of about 7. The final toner batches, which are denoted as particles A, B and C, had a particle size of from about 5.8 to about 6.1 microns and a circularity of from about 0.963 to about 0.967.

Three developers were then prepared: the first included the toner blended with an additive package, sometimes referred to herein, in embodiments, as Additive Package 1, including 0.88% by weight TiO2 treated with a decylsilane (commercially available as JMT 2000 from Tayca), 1.73% by weight X24 (a sol-gel silica commercially available from Shin-Etsu Chemical), 0.55% by weight E10) (a cerium oxide commercially available from Mitsui Mining), 0.9% by weight Unilin 700 wax commercially available from Baker Petrolite and about 1.71% by weight RY50 silica, a polydimethylsiloxane treated silica commercially available from Evonik Degussa with high amounts of free polydimethyl siloxane (PDMS), about 50,700 ppm of PDMS; the second included the toner blended with an additive package, sometimes referred to herein, in embodiments, as Additive Package 2, including about 0.88% by weight STT100H (a titania treated with iso-butylsilane commercially available from Titan Kogyo), about 1.73% by weight X24 (a sol-gel silica commercially available from Shin-Etsu Chemical), about 0.28% by weight E10 (a cerium oxide commercially available from Mitsui Mining), about 0.86% by weight RX50 (a hexamethylsilazane treated silica commercially available from Evonik Degussa), about 1.28% by weight RY50 silica and about 0.18% by weight zinc stearate (ZnSt); and the third included the toner blended with an additive package, sometimes referred to herein, in embodiments, as Additive Package 3, including about 0.88% by weight TiO₂ (commercially available as JMT 2000 from Tayca), about 1.73% by weight X24 (a sol-gel silica commercially available from Shin-Etsu Chemical), about 0.55% by weight E10 (a cerium oxide commercially available from Mitsui Mining), about 0.9% by weight Unilin 700 wax commercially available from Baker Petrolite), and about 1.71% by weight HDK H05TD silica from Wacker, which contained low amounts of free PDMS, about 560 ppm of PDMS.

Analytical NMR methods were used to identify the amount of free PDMS content in the H05TD silica, compared with the RY50 silica. Approximately 20 mg of each sample were dispersed in about 550 μL of deuterated chloroform combined with about 10 mg of mesitylene as a reference. Exact weights of the samples and mesitylene were recorded. ¹H NMR spectra were measured on a Bruker AV-500 NMR spectrometer.

The amount of dissolved PDMS was quantified by integrating characteristic peaks near 0 ppm, which were attributed to S₁—CH₃ groups. Integrals were normalized using mesitylene as a reference. Due to the nature of NMR experiments, only the solubilized portion of the PDMS was observed. Results of the quantitative analysis of the spectra are listed below in Table 1.

TABLE 1

| Silica Sample | Free PDMS content |
|---|---|
| RY50 | 50,700 ppm |
| HDK H05TD | 560 ppm |

Since the PDMS numbers for the RY50 silica sample were unusually high, the measurements were repeated using a kerosene extraction procedure (which was less sensitive from NMR standpoint, but did not require the additional reference). The measurements yielded free PDMS at about 5 percent by weight (50,000 ppm) for the RY50 silica, thus confirming the original results. The results thus showed much less free PDMS in the commercially available HDK H05TD silica than the RY50 silica.

A first toner, toner A, was blended with two controls including the Additive Package 2 and the Additive Package 3 as described above.

Charging characteristics for the toners were obtained by placing about 0.5 grams of toner in a glass jar containing about 10 grams of Xerox 700 Digital Color Press carrier. The jar with toner and carrier was conditioned under environmental conditions overnight: A-zone at about 28° C. and about 85% relative humidity (RH) and C-zone at about 10° C. and about 15% relative humidity (RH). The jar was placed on a Turbula mixer and shaken for varying amounts of time, from about 2 minutes to about 60 minutes.

Triboelectric charge of the developer in microcoulombs per gram was obtained at relevant time points by the total blow-off method at 55 psi air pressure.

The toner charge was also measured using a charge spectrograph. The charged toner was removed from the carrier using a jet of air to entrain the toner into the inlet of the charge spectrograph, where the toner was carried down a 30 cm long column with a laminar flow of air and a perpendicular 100 V/cm electric field. The toner charge (Q/d) was measured visually as the midpoint of the toner charge distribution on a porous substrate located at the bottom of the column. The toner charge was reported in millimeters of displacement from the zero line. Toner charge per mass ratio (Q/m) was also calculated. Utilizing this equipment, calibration showed a charge displacement of 1 millimeter corresponding to a Q/d of 0.092 femto coulombs per micron.

Toner blocking was determined by measuring the toner cohesion at temperatures above room temperature. Toner blocking measurement was obtained as follows: two grams of additive toner were weighed into an open dish and conditioned in an environmental chamber at the specified temperature and 50% relative humidity. After about 17 hours, the samples were removed and acclimated in ambient conditions for about 30 minutes. Each re-acclimated sample was measured by sieving through a stack of two pre-weighed mesh sieves, which were stacked as follows: 1000 μm on top and 106 μm on bottom. The sieves were vibrated for about 90 seconds at 1 mm amplitude with a Hosokawa flow tester. After the vibration was completed, the sieves were reweighed and toner blocking was calculated from the total amount of toner remaining on both sieves as a percentage of the starting weight. Thus, for example, for a 2 gram toner sample, if A is the weight of toner left on the top 1000 μm screen, and B is the weight of toner left on the bottom 106 μm screen, the toner blocking percentage is calculated by: % blocking=50 (A+B).

The toner blended with Additive Package 3, including the HDK H05TD silica from Wacker, which contained low amounts of free PDMS, had similar charging performance in the bench and in machine, while demonstrating improved resistance to blocking compared to the other toners. More specifically, the sample with bad blocking performance possessed the Additive Package 1 toner, including the RY50 silica. The RY50 silica had much larger amounts of free PDMS, 50,700 ppm (or 5.07% by weight), compared with the 560 ppm free PDMS observed for the HDK H05TD silica included in the Additive Package 3 toner sample, which demonstrated good blocking performance.

Table 2 below illustrates the bench results of the toners with Additive Package 1, possessing RY50 silica, and Additive Package 3, possessing HDK H05TD silica. Both packages met the bench charging specifications; however, the toner with the Additive Package 1 failed the blocking heat cohesion test.

TABLE 2

| | A-zone | | | C-zone | |
|---|---|---|---|---|---|
| | 60′ Q/d | 60′ Q/m | 2′ Q/m | 60′ Q/d | 60′ Q/m |
| Sample | (mm) | (μC/g) | (μC/g) | (mm) | (μC/g) |
| Targets | >4 | | >33 | <11 | |
| Toner with Additive | 7.5 | 28.9 | 30.1 | 10.4 | 35.3 |
| Package 1 | | | | | |
| Toner with Additive | 8.0 | 28.0 | 39.4 | 11.7 | 37.6 |
| Package 3 | | | | | |

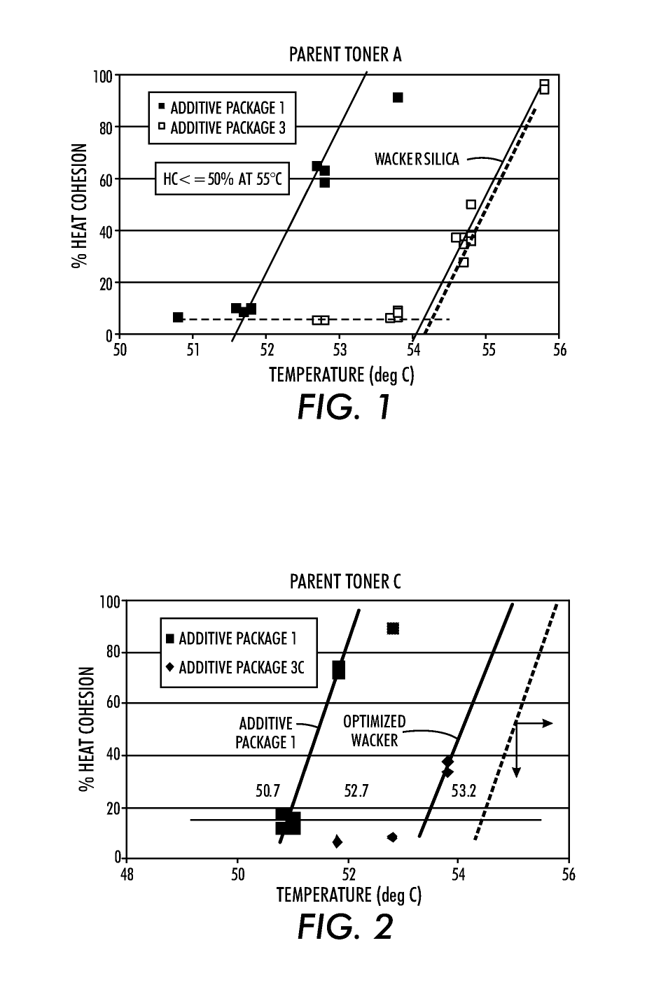

Blocking data is also included in FIG. 1, which includes a graph depicting toner blocking for the toners possessing Additive Package 1 and Additive Package 3. Additive Package 1, which had high residual PDMS silica, showed an onset of blocking, defined as the temperature where measured toner cohesion began to rapidly increase with temperature, of about 51.7° C., compared to an onset of blocking of the toner with Additive Package 3 of about 54° C., over a 2° C. improvement. Blocking failure, the point at which the cohesion is 50% was similarly improved, from 52.4° C. for package 1 to 55° C. for package 3, again over a 2° C. improvement.

Optimization of blocking data is set forth in FIG. 2. Two different additive packages were blended on parent toner C. The Wacker H05TD optimized additive package, herein in embodiments denoted as Additive Package 3C, was about 1.827% JMT2000, about 1.59% Wacker H05TD, about 1.73% X24, about 0.55% E10, about 0.9% UADD and the Additive Package 1 described above. Both toners with the different additive packages met all developer charge requirements, but the optimized Additive Package 3C with Wacker H05TD had an onset of blocking temperature of 53.2° C. compared to 50.7° C. for the Additive Package 1, and similarly, the temperature for blocking failure of 50% cohesion was 54° C. for the optimized Additive Package 3C with Wacker H05TD (matching the target blocking performance) compared to 51.5° C. for the Additive Package 1, an improvement of 2.5° C.

In addition to bench work, an extensive set of machine testing, toner concentration latitude testing (TC latitude testing) was done to assure that the additive formulation with HDK H05TD silica provided required performance in print testing. The print testing was done in a Xerox WCP3545 printer. All testing was done on toners blended using parent toner A.

The examples in the table below show the machine performance of toners with the RY50 silica compared with the 1:1 replacement of RY50 silica with H05TD silica. The TC altitude test was done at 8% TC, 13% TC and 5% TC in A zone conditions. The results in Table 3 below show similar performance, except for higher unacceptable background at higher TC.

TABLE 3

| | | | Background | Solid | |
|---|---|---|---|---|---|
| | | | at Vclean = | mottle | Solid |
| | | | 120 V ≦ | (NMF) | graininess |
| Additive Package | TC % | Aₜ | 0.02 | ≦Grade 2 | ≦Grade 3 |
| Additive Package 1 | 8 | 364 | 0.004 | grade 1 | grade 1 |
| Additive Package 3 | 8 | 331 | 0.008 | grade 1 | grade 1 |
| Additive Package 1 | 13 | 329 | 0.01 | grade 0 | grade 1 |
| Additive Package 3 | 13 | 401 | 0.053 | grade 1 | grade 1 |
| Additive Package 1 | 5 | 303 | 0.000 | grade 1 | grade 1 |
| Additive Package 3 | 5 | 281 | 0.006 | grade 1 | grade 2 |

Aₜ = q/m · (TC + 4)
Vclean = cleaning field voltage
NMF = noise at mottle frequency

To overcome the higher background at higher TC in higher RH conditions, an experiment was planned to follow up and to optimize silica SAC (surface area coverage, which is a strong driver for toner blocking) and silica to titania ratio. A small range of SAC and the ratio of the two oxides were reviewed.

The examples in Table 4 below show the results observed with 1:1 replacement of RY50 with HDK H05TD. A high SAC and low silica to titania ratio was obtained. The machine xerographic performance was evaluated by print testing in a Xerox DC250 or DC252 copier, and performance was similar for all four examples except that the transfer efficiency was marginally lower than the 2A Additive Package.

TABLE 4

| | | | | | | Solid | |
|---|---|---|---|---|---|---|---|
| | | | | | Background | mottle | Solid |
| Parent | | | | % TE ≧ | at Vclean = | (MNF) | graininess |
| Toner | Additive Package | machine | Aₜ | 85 | 120 V ≦ 0.02 | ≦Grade 2 | ≦Grade 3 |
| B | Additive Package 1 | DC250 | 380 | 85 | 0.002 | <grade 1 | <grade 1 |
| B | Additive Package 3 | DC250 | 410 | 85 | 0.002 | <grade 1 | <grade 1 |
| | HO5TD (1:1) | | | | | | |
| B | Additive Package 3A | DC250 | 368 | 86 | 0.003 | grade 1 | grade 1 |
| | HO5TD (High SAC | | | | | | |
| | and Low silica/titania | | | | | | |
| | ratio) | | | | | | |
| C | Additive Package 2 | DC252 | 455 | 91 | −0.001 | grade 1 | <grade 1 |

Note:
All data was collected in A-zone (temp 28° C. and 85% RH)
Additive Package 3A (High SAC and Low silica/titania ratio): was about 1.345% by weight of the toner JMT2000, 1.97% by weight of the toner Wacker HO5TD, 1.73% by weight of the toner X24, 0.55% by weight of the toner E10, 0.9% by weight of the toner UADD

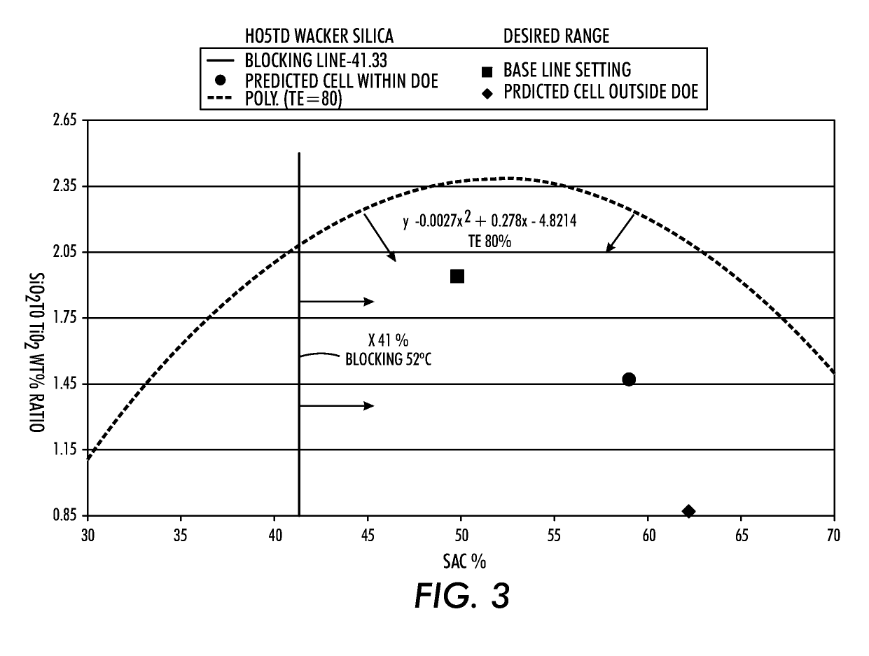

A design of experiment (DOE) was done to understand the drivers for toner performance under different environmental conditions based on different levels of inventive Wacker H05TD silica and JMT2000 titania in the toner. All toners were blended using parent toner C. The DOE studied two factors, surface area coverage and silica to titania ratio both at three levels of from about 37.3 to about 62.2% Wacker H05TD, and from about 1.47 to about 2.44% JMT 2000 titania; while keeping the other three additives at a constant level of, 1.73% by weight of the toner X24, 0.55% by weight of the toner E10, 0.9% by weight of the toner UADD. Six out of a total of 13 bench and machine responses were selected which had strong correlations with the two input factors. The DOE was followed by a robust design study to optimize the silica and titania loadings and minimize the number of defects for the bench and machine performances, which resulted in the data set forth in FIG. 3 which shows that a toner with surface additives including one or more PDMS treated silicas with low extractable PDMS and one or more titanias where:

41≦X≧70, 0.85≦Y≧2.4, and Y≦−0.0027X+0.278X−4.8214;

where, Y is the total SiO2/TiO2 ratio and X is the total SAC of all SiO2 and TiO2.

Table 5 below shows that the predicted settings from the robust parameter design (SAC: 59% and Si/Ti ratio: 1.47) improved blocking, but transfer efficiency (TE) was still around the target compared to the base line setting with RY50 and the 1:1 replacement of H05TD. A higher SAC (62.2%) and lower Si/Ti ratio (0.87) improved both blocking and TE. The Sigma level, which is the number of standard deviations of the measured property that are within the specification limits, and thus which measures the robustness of the design to provide required performance for blocking temperature, improved from 6.4 to 11 and for transfer efficiency from −0.75 to 1.4, compared to those at the original settings (SAC: 49.8% and Si/Ti ratio: 1.94). Sigma level for Aₜ and background (BKG) were close to 3 or higher. Sigma level≧3 indicated that all responses were robust to the variations in the input factors.

TABLE 5

| | | At-T0 | TE-T0 | Blocking T | BKG 120V 13% |
|---|---|---|---|---|---|
| | Lower Spec | 300 | 85 | 51.5 | |
| | Upper Spec | 530 | | | 0.02 |
| Package 1 | Mean | 380 | 85 | 51.5 | 0.014 |
| Base line setting | dpm | N/A | N/A | N/A | N/A |
| SAC = 49.8 Si/Ti | Sigma Level | N/A | N/A | N/A | N/A |
| ratio = 1.94 (RY50) | | | | | |
| Package 3 | Mean | 405 | 83 | 52.6 | 0.007 |
| Base line setting | dpm | 0.166 | 772989.701 | 0.000 | 1017.160 |
| SAC = 49.8 Si/Ti | Sigma Level | 5.105 | −0.749 | 6.404 | 3.085 |
| ratio = 1.94 | | | | | |
| (HO5TD) | | | | | |
| Package 3B | Mean | 387.0 | 85.5 | 53.5 | 0.0019 |
| Predicted cell from | dpm | 36.717 | 418,249.855 | . | 7.115 |
| EVA within DOE | Sigma Level | 3.96 | 0.206 | 9.815 | 4.34 |
| SAC = 59 Si/Ti | | | | | |
| ratio = 1.47 | | | | | |
| Package 3C | Mean | 454.8 | 88.8 | 53.9 | −0.0005 |
| Predicted cell from | dpm | 1,661.141 | 77,014.662 | . | .469 |
| EVA outside DOE | Sigma Level | 2.936 | 1.425 | 10.988 | 4.904 |
| SAC = 62.2 Si/Ti | | | | | |
| ratio = 0.87 | | | | | |

dpm = defects per million, the predicted fraction of out of specification performance that would be measured if toners were made with this additive package, due to experimental variations in the inputs of the correct additive loadings.

Package 3B predicted cell from EVA within DOE additive package was: 1.272% by weight of the toner JMT2000, 1.87% by weight of the toner Wacker H05TD, 1.73% by weight of the toner X24, 0.55% by weight of the toner E10, 0.9% by weight of the toner UADD.

Package 3C predicted cell from EVA outside DOE additive package was: 1.827% by weight of the toner JMT2000, 1.59% by weight of the toner Wacker H05TD, 1.73% by weight of the toner X24, 0.55% by weight of the toner E10, 0.9% by weight of the toner UADD

The bench charging and blocking test were performed using the predicted package. The results met all bench requirements and the highest blocking Temperature was achieved. The data obtained is summarized in Table 6 below:

TABLE 6

| | | | | | | Charge | | Blocking | |
|---|---|---|---|---|---|---|---|---|---|
| | A-zone data | | | C-zone data | | Maintenance | | Temperature | |
| | 60′ Q/d | 60′ Q/m | 2′ Q/m | 60′ Q/d | 60′ Q/m | 24 h | 7 day | onset | failure |
| Targets | 4 < qd < 11 | | >33 | 4 < qd < 11 | | >80 | >66 | | >=55° C. |
| Additive | 8.7 | 41 | 40 | 11.7 | 52 | 1 | 82 | 50.7 | 51.5 |
| Package 1 | | | | | | | | | |
| Additive | 7.7 | 40 | 48 | 14.0 | 65 | 84 | 59 | 52.7 | 53.4 |
| Package 2 | | | | | | | | | |
| Additive | 7.0 | 34 | 30 | 12.1 | 50 | 87 | 69 | 53.2 | 54 |
| Package 3C | | | | | | | | | |

### Example 2

Additional experiments were run with a fluorine treated titanium dioxide, which replaced the TiO2 found in Additive Packages 1 and 3 of Example 1 above. The table below illustrates the bench results of the above toners of Example 1 with Additive Package 1 including RY50 silica, and the Additive Package 3 with the HDK H05TD silica, in combination with the fluorine treated titanium dioxide, STT100H-F10, commercially available from Titan Kogyo, instead of the titanium dioxide provided with Additive Packages 1 and 3 of Example 1 above (JMT 2000). All toners were blended using the parent toner C. Both toners with Additive Package 1 and 3 met the bench charging specifications; however, the toner with Additive Package 1 failed the blocking heat cohesion test with onset blocking temperature at 50.7° C. and blocking failure at 51.5° C. Replacing the TiO2 of Additive Packages 1 and 3 with STT100H (an iso-butylsilane treated titania available commercially from Titan Kogyo), or STT100H-F10, increased toner blocking resistance, increased toner charging, and decreased RH sensitivity.

A summary of the results is set forth in Table 7 below.

TABLE 7

| | | | | | Blocking | |
|---|---|---|---|---|---|---|
| | A-zone | | C-zone | | Onset | Failure |
| | Q/d | Q/m | Q/d | Q/m | Temperature | Temperature |
| | (mm) | (μC/g) | (mm) | (μC/g) | (° C.) | (° C.) |
| Targets | 4 < Q/d < 11 | | 4 < Q/d < 11 | | | >=55 |
| Additive Package 1 | 7.8 | 32 | 13.6 | 55 | 50.7 | 51.5 |
| Additive Package 3 | 7.3 | 35 | 13.2 | 57 | 52.7 | 53.4 |
| Additive Package 3 | 7.6 | 38 | 14.2 | 68 | 53.7 | 54.4 |
| replacing JMT2000 | | | | | | |
| by STT100H | | | | | | |
| Additive Package 3 | 7.8 | 46 | 14.5 | 72 | 53.7 | 54.4 |
| replacing JMT2000 | | | | | | |
| by STT100H-F10 | | | | | | |

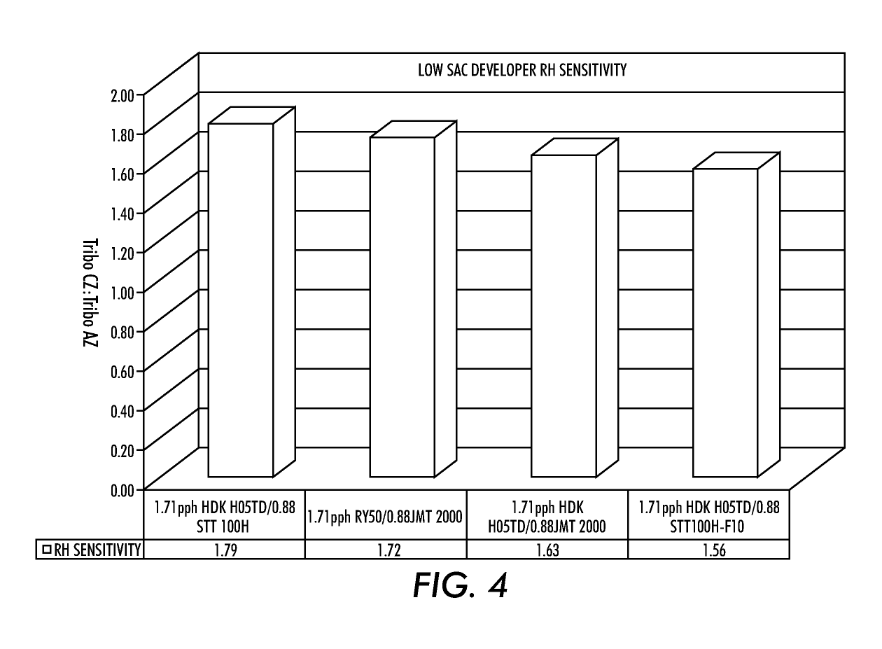

The improvement observed in RH sensitivity of the developers with the fluorine treated titanium dioxide is depicted in FIG. 4. As depicted in FIG. 4, improvements found by the inclusion of fluorinated treated titanium dioxide in toner compositions may permit toner designs with lower amounts of silica, thereby changing the Si to Ti ratio.

For comparison only, the Additive Package 2 described in Example 1 above was tested with the fluorine treated TiO2. The improvement in blocking noted above with the low PDMS silica additive package (Additive Package 3) was not observed.

The above results suggest that an interaction occurred with the excess of PDMS from the RY50 silica and the fluorinated treated titania, preventing any further improvement to the blocking resistance. A summary of the results that were observed are set forth in Table 8 below.

TABLE 8
High surface area coverage package, high cost

| | | | | | | Blocking |
|---|---|---|---|---|---|---|
| | | | | | Blocking Onset | Failure |
| | Q/d | Q/m | Q/d | Q/m | Temperature | Temperature |
| | (mm) | (μC/g) | (mm) | (μC/g)) | (° C.) | (° C.) |
| Targets | 4 < Q/d < 11 | | 4 < Q/d < 11 | uC/g | | >=55 |
| Additive Package 2 | 7.9 | 38 | 14.3 | 58 | 52.7 | 53.4 |
| Additive Package 2 with | 8.5 | 44 | 16.0 | 83 | 52.7 | 53.4 |
| STT100H-F10 replacing | | | | | | |
| STT100H | | | | | | |

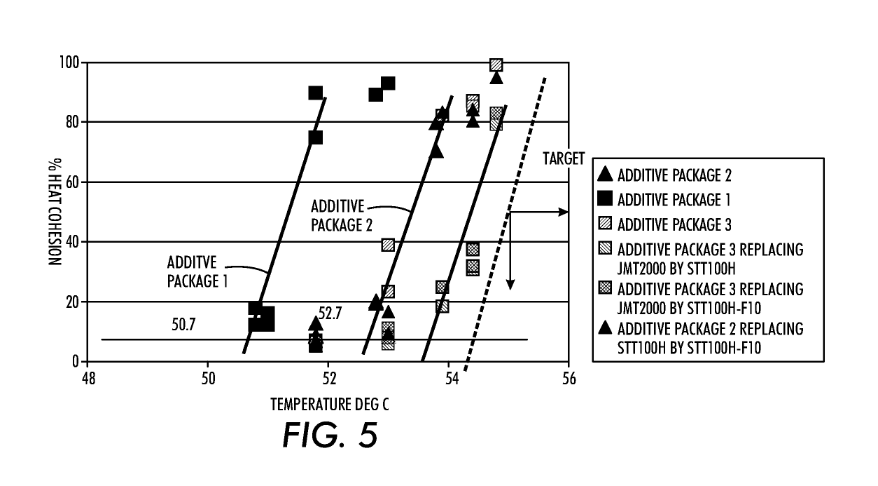

Blocking data are also included in FIG. 5, which includes a graph depicting toner blocking for the toners possessing Additive Package 1, Additive Package 2 and Additive Package 3, and also replacing the titanium dioxide in these packages with the fluorine treated titanium dioxide, STT100H-F10.

Inductively coupled plasma analysis was conducted on the toners shown in Table 7 to determine the % Si and % Ti in the toners. The results are summarized in Table 9 below. As can be seen in Table 9, for the same input amount of silica and titania the HDK H05TD Silica and the STT100H-F10 fluoro-treated titania were present in higher concentrations on the toner.

TABLE 9

| | ICP | ICP |
|---|---|---|
| | % Si | % Ti |
| Additive Package 1 | 1.37 | 0.44 |
| Additive Package 3 | 1.41 | 0.38 |
| Additive Package 3 and STT100H | 1.41 | 0.37 |
| Additive Package 3 and STT100H-F10 | 1.41 | 0.44 |

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A toner comprising:
a resin;
an optional colorant;
an optional wax; and
at least one additive comprising a silica treated with a polydimethyl siloxane, having from about 0 ppm by weight to about 10,000 ppm by weight free polydimethyl siloxane.

2. The toner according to claim 1, wherein the resin comprises at least one amorphous resin, optionally in combination with at least one crystalline resin, and wherein the total surface area coverage of the at least one additive is from about 35 to about 80.

3. The toner according to claim 1, wherein the resin comprises at least one amorphous polyester resin in combination with at least one crystalline resin.

4. The toner according to claim 1, wherein the resin comprises at least one amorphous polyester resin of the formula: 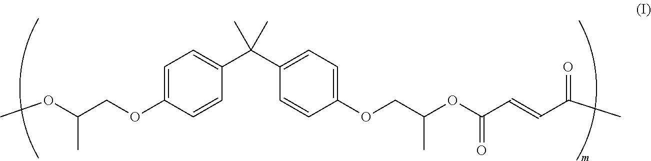
wherein m may be from about 5 to about 1000, in combination with at least one crystalline polyester resin of the formula: 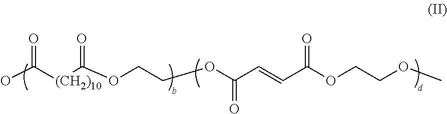
wherein b is from about 5 to about 2000 and d is from about 5 to about 2000.

5. The toner according to claim 1, wherein the optional colorant comprises dyes, pigments, combinations of dyes, combinations of pigments, and combinations of dyes and pigments in an amount of from about 0.1 to about 35 percent by weight of the toner, and wherein the optional wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof, present in an amount from about 1 weight percent to about 25 weight percent of the toner.

6. The toner according to claim 1, wherein the silica treated with the polydimethyl siloxane is present in an amount of from about 0.5% by weight of the toner to about 3% by weight of the toner.

7. The toner according to claim 1, wherein the at least one additive further comprises a titanium dioxide treated with fluorine, the fluorine present in an amount of from about 1% by weight of the titanium dioxide to about 20% by weight of the titanium dioxide.

8. The toner according to claim 7, wherein the titanium dioxide treated with fluorine is present in an amount of from about 0.1% by weight of the toner to about 2.5% by weight of the toner.

9. The toner according to claim 7, wherein the ratio of silicon dioxide to titanium dioxide in the toner is from about 0.5:1 to about 2.7:1.

10. The toner of claim 1, wherein the toner possesses a charge of from about 15 μC/g to about 70 μC/g at about 85% relative humidity and a temperature of about 28° C., and wherein the toner possesses a blocking temperature of from about 53.5° C. to about 60° C.

11. A toner comprising:
at least one amorphous polyester resin, optionally in combination with at least one crystalline polyester resin;
an optional colorant;
an optional wax; and
at least one additive comprising a silica treated with a polydimethyl siloxane, having from about 0 ppm by weight to about 10000 ppm by weight free polydimethyl siloxane, in combination with titanium dioxide treated with fluorine, the fluorine present in an amount of from about 1% by weight of the titanium dioxide to about 20% by weight of the titanium dioxide.

12. The toner according to claim 11, wherein the at least one amorphous polyester resin is of the formula: 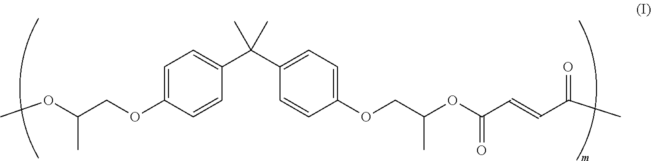
wherein m may be from about 5 to about 1000, and the at least one crystalline polyester resin is of the formula: 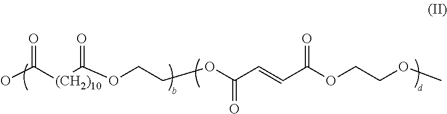
wherein b is from about 5 to about 2000 and d is from about 5 to about 2000.

13. The toner according to claim 11, wherein the optional colorant comprises dyes, pigments, combinations of dyes, combinations of pigments, and combinations of dyes and pigments in an amount of from about 0.1 to about 35 percent by weight of the toner, and wherein the optional wax is selected from the group consisting of polyolefins, carnauba wax, rice wax, candelilla wax, sumacs wax, jojoba oil, beeswax, montan wax, ozokerite, ceresin, paraffin wax, microcrystalline wax, Fischer-Tropsch wax, stearyl stearate, behenyl behenate, butyl stearate, propyl oleate, glyceride monostearate, glyceride distearate, pentaerythritol tetra behenate, diethyleneglycol monostearate, dipropyleneglycol distearate, diglyceryl distearate, triglyceryl tetrastearate, sorbitan monostearate, cholesteryl stearate, and combinations thereof, present in an amount from about 1 weight percent to about 25 weight percent of the toner.

14. The toner according to claim 11, wherein the silica treated with the polydimethyl siloxane is present in an amount of from about 0.5% by weight of the toner to about 3% by weight of the toner, and wherein the titanium dioxide treated with fluorine is present in an amount of from about 0.1% by weight of the toner to about 2.5% by weight of the toner.

15. The toner according to claim 11, wherein the ratio of silicon to titanium in the toner is from about 0.5:1 to about 2.7:1.

16. The toner of claim 11, wherein the toner possesses a charge of from about 15 μC/g to about 70 μC/g at about 85% relative humidity and a temperature of about 28° C.

17. The toner of claim 11, wherein the toner possesses a blocking temperature of from about 53.5° C. to about 60° C.

18. A toner comprising:
at least one amorphous polyester resin, optionally in combination with at least one crystalline polyester resin;
an optional colorant;
an optional wax; and
at least one additive comprising a silica treated with a polydimethyl siloxane, having from about 0 ppm by weight to about 10,000 ppm by weight free polydimethyl siloxane, in combination with titanium dioxide treated with fluorine, the fluorine present in an amount of from about 1% by weight of the titanium dioxide to about 20% by weight of the titanium dioxide,
wherein the silica treated with the polydimethyl siloxane is present in an amount of from about 0.5% by weight of the toner to about 3% by weight of the toner, and wherein the titanium dioxide treated with fluorine is present in an amount of from about 0.1% by weight of the toner to about 2.5% by weight of the toner.

19. The toner according to claim 18, wherein the at least one amorphous polyester resin is of the formula: 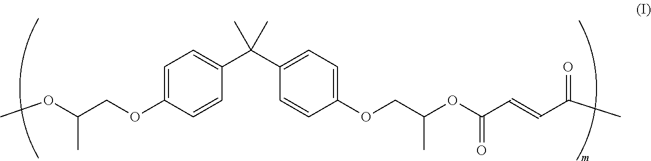
wherein m may be from about 5 to about 1000, and the at least one crystalline polyester resin is of the formula: 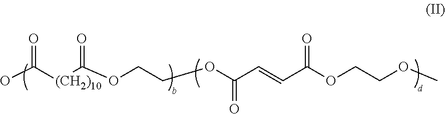
wherein b is from about 5 to about 2000 and d is from about 5 to about 2000.

20. The toner according to claim 18, wherein the ratio of silicon dioxide to titanium dioxide ratio in the toner is from about 0.5:1 to about 2.7:1, the toner possesses a charge of from about 15 μC/g to about 70 μC/g at about 85% relative humidity and a temperature of about 28° C., and wherein the toner possesses a blocking temperature of from about 53.5° C. to about 60° C.
